(19) United States
(12) Patent Application Publication
(10) Pub. No.: US 2023/0193846 A1
(43) Pub. Date: Jun. 22, 2023

(54) METHOD FOR OPERATING AN INTERNAL COMBUSTION ENGINE, CONTROL UNIT FOR AN INTERNAL COMBUSTION ENGINE, AND INTERNAL COMBUSTION ENGINE

(71) Applicant: Rolls-Royce Solutions GmbH, Friedrichshafen (DE)

(72) Inventors: Jörg Remele, Hagnau (DE); Aron Toth, Friedrichshafen (DE); Tobias Frank, Friedrichshafen (DE)

(73) Assignee: Rolls-Royce Solutions GmbH, Friedrichshafen (DE)

(21) Appl. No.: 18/109,587

(22) Filed: Feb. 14, 2023

Related U.S. Application Data
(63) Continuation of application No. PCT/EP2021/072823, filed on Aug. 17, 2021.

(30) Foreign Application Priority Data
Aug. 20, 2020 (DE) 10 2020 210 625.8
Aug. 17, 2021 (WO) PCT/EP2021/072823

(51) Int. Cl. F02D 41/40

(52) U.S. Cl. CPC F02D 41/401; F02D 2200/0602; F02D 2041/389

(57) ABSTRACT

A method for operating an internal combustion engine, the method including the steps of:
(a) actuating an injector to introduce a pre-injection amount of a fuel into a combustion chamber of the internal combustion engine;
(b) determining, for an operating cycle of the combustion chamber in which the injector was actuated in the step (a), a pressure gradient characteristic value which is characteristic of a combustion chamber pressure gradient in the combustion chamber;
(c) repeating the steps (a) and (b) a plurality of times;
(d) determining a skew of a distribution of a plurality of pressure gradient characteristic values determined in the step (c); and
(e) changing or maintaining an actuation of the injector depending on the skew determined in the step (d).

### CROSS REFERENCE TO RELATED APPLICATIONS

This is a continuation of PCT application No. PCT/EP2021/072823, entitled “METHOD FOR OPERATING AN INTERNAL COMBUSTION ENGINE, CONTROL UNIT FOR AN INTERNAL COMBUSTION ENGINE, AND INTERNAL COMBUSTION ENGINE”, filed Aug. 17, 2021, which is incorporated herein by reference. PCT application No. PCT/EP2021/072823 claims priority to German patent application no. 10 2020 210 625.8, filed Aug. 20, 2020, which is incorporated herein by reference.

### BACKGROUND OF THE INVENTION

### 1. Field of the Invention

The present invention relates to a method for operating an internal combustion engine, control unit for an internal combustion engine, and internal combustion engine equipped with such a control unit.

### 2. Description of the Related Art

In order to reduce a combustion chamber pressure gradient, in particular a peak pressure gradient, during internal combustion in an internal combustion engine and thus reduce the mechanical load on the internal combustion engine, a pre-injection is often conducted. Not the least, this enables internal combustion engines to be operated efficiently with low emissions. However, to keep the combustion chamber pressure gradient low, the amount of fuel introduced into the combustion chamber during pre-injection must be precisely measured because the combustion chamber pressure gradient increases significantly not only if the pre-injection amount of fuel is too low, but also if the pre-injection amount of fuel is too high. However, injectors typically found on internal combustion engines do not offer sufficient reproducibility, especially when comparatively small amounts of fuel are to be injected. In particular, shot-to-shot dispersion of the injected amount of fuel is high if such an injector is repeatedly actuated in exactly the same way. Furthermore, effects of aging may occur which—with unchanged actuation—can lead to changes in the injection amount over the service life of the injector. Therefore, however, with defined actuation of an injector, the exact amount of fuel introduced into the combustion chamber is generally unknown. Furthermore, the effect of pre-injection is not directly controllable.

Even if the combustion chamber pressure gradient can be recorded indirectly, for example via a structure-borne sound sensor, evaluation remains difficult. If for example, an iterative search for an extreme value is implemented via a metric, the optimum can only be determined by trial and error, that is by varying an actuation correction, especially since metrics obtained from structure-borne sound signals do not allow absolute conclusions to be drawn about the actual combustion chamber pressure gradient. This costs time and also results in that even actually suitable actuations are moved away from the optimum by constant tentative testing or continue to be subjected to iterative optimization, which simply is due to the fact that there is no knowledge of whether the current actuation of the injector is already close to the optimum value or not. This leads to protracted and poorly converging procedures, especially if the applied metric has a very flat progression in the range of the extreme value that is searched for.

What is needed in the art is a method for operating an internal combustion engine, a control unit for an internal combustion engine, and an internal combustion engine, wherein the aforementioned disadvantages are at least reduced, optionally completely avoided.

### SUMMARY OF THE INVENTION

The present invention provides a method for operating an internal combustion engine, in which a) an injector is actuated to introduce a pre-injection amount of a fuel into a combustion chamber of the internal combustion engine. A pressure gradient characteristic value is determined b) for an operating cycle of the combustion chamber in which the injector was actuated in step a), which is characteristic of a combustion chamber pressure gradient in the combustion chamber. Steps a) and b) are repeated multiple times in c). In step d) a skew of a distribution of the pressure gradient characteristic values determined in step c) is determined, and the actuation of the injector is changed or maintained e) depending on the skew determined in step d). Suitable drive signals that do not require any significant correction can already be advantageously detected without iteration, and in particular a rapid convergence of the extreme value search for the suitable actuation becomes possible. The herein proposed method does not evaluate an average integral metric to obtain the optimal actuation of the injector in terms of a minimum combustion chamber pressure gradient, but rather adopts a statistical approach. The method according to the present invention advantageously makes use of the fact that the relationship between the pre-injection amount and the combustion chamber pressure gradient or its estimation is not linear. Considering the effect of multiple pre-injections, which scatter around an average value in the actual amount of fuel introduced, upon the resulting values of the combustion chamber pressure gradient or the estimation thereof, a statistical distribution of these values results. This distribution differs significantly depending on whether one is near the minimum of the function or at a distance therefrom.

To understand this, consideration is given (compare FIG. 2) to a plot of the combustion chamber pressure gradient or, alternatively, to an estimate of the combustion chamber pressure gradient depending on the pre-injection amount according to a specified metric. For the sake of simplicity, we will refer only to the combustion chamber pressure gradient below, however this includes the fact that this may be an estimated value of the combustion chamber pressure gradient according to a specified metric. The plot of the combustion chamber pressure gradient against the pre-injection amount shows a minimum at an optimum value of the pre-injection amount, which is also assigned to an optimum actuation of the injector. Originating from this minimum, the combustion chamber pressure gradient increases to both lower and higher pre-injection amounts However, the combustion chamber pressure gradient curve shows a very flat progression in the range of the minimum, rising steeply to smaller pre-injection amounts, while rising initially comparatively slowly toward larger pre-injection amounts and subsequently rising more steeply. The fact that the range of the minimum is flat means, in particular, that in the range of the minimum of the combustion chamber pressure gradient curve, a variation of the pre-injection amount around the optimum value barely leads to a change in the combustion chamber pressure gradient.

If one now assumes that the actually introduced pre-injection amounts are distributed in a Gaussian manner or in accordance with another symmetrical distribution around the optimum value, the result is that the associated combustion chamber pressure gradient values are essentially in the range of the minimum combustion chamber pressure gradient, wherein the associated distribution of combustion chamber pressure gradients show no values smaller than the minimum, wherein the relative frequency of the combustion chamber pressure gradient values decreases towards larger combustion chamber pressure gradient values. Close to the minimum, the distribution of combustion chamber pressure gradient values is therefore maximally skewed, in other words asymmetrical, with the most frequent values being at the edge of the distribution near the minimum, since a deviation in the direction of greater as well as smaller pre-injection amounts leads to higher combustion chamber pressure gradients.

In contrast, the maximum of the distribution of the combustion chamber pressure gradient values moves increasingly in the direction of the center of the value range of the sample or group of values considered, the greater the distances of the mean value of the—still thought of as symmetrical—pre-injection amount distribution from the optimum value. The distribution of the combustion chamber pressure gradient values thus becomes less and less skewed and increasingly symmetrical the further removed the mean value of the distribution of the pre-injection amount is from the optimum values.

The skew of the distribution of combustion chamber pressure gradient values—and thus also of the pressure gradient characteristic values of the method proposed herein—thus represents a robust and clear criterion for how well suited the current actuation of the injector is to lead, on average, to a pre-injection amount that keeps the combustion chamber pressure gradient near its minimum.

Thus, it can be determined in a simple and rapid manner, in particular without iteration, how good the current actuation of the injector is and, if necessary, a rapid convergence towards a suitable actuation can be found.

The injector is optionally controlled with a specific duration of energization. In particular, actuation of the injector means an actuation with a specific duration of energization. A change in actuation means, in particular, a change in the duration of energization. Accordingly, maintaining actuation means, in particular, maintaining a certain duration of energization. Actuation is thus defined in particular by the duration of energization with which the injector is actuated.

Fuel introduced into the combustion chamber via the injector is optionally a self-igniting fuel, in particular diesel or dimethyl ether, or a burnable gas.

The pre-injection amount of fuel is introduced into the combustion chamber by the injector, in particular by way of pre-injection, with subsequent main injection following within the same operating cycle. A much smaller amount of fuel is introduced by way of pre-injection compared to the amount of fuel introduced with the main injection, which includes a smaller proportion of the chemical energy introduced into the combustion chamber within the operating cycle than the amount of fuel introduced with the main injection. In this context, the previously described problem arises in measuring the pre-injection amount: a typical injector is designed to inject the main injection amount as precisely as possible. Since the pre-injection amount is much smaller than the main injection amount, it is hardly possible to define it precisely via the actuation of the injector.

The fact that the pressure gradient characteristic value is characteristic for a combustion chamber pressure gradient means, in particular, that the pressure gradient characteristic value correlates with the combustion chamber pressure gradient; the pressure gradient characteristic value is in particular derivable or can be derived from the combustion chamber pressure gradient; or conversely, the combustion chamber pressure gradient can be derived—at least in principle—from the pressure gradient characteristic value.

The combustion chamber pressure gradient is in particular optionally a peak pressure gradient.

A pressure gradient is understood to be a derivative of pressure with respect to time. Thus, the pressure gradient is a temporal pressure gradient.

In step c), steps a) and b) are repeated in particular multiple times with the same actuation of the injector. Step c) is thus optionally conducted in a stationary state of the internal combustion engine. Optionally, the entire procedure is conducted in a stationary state of the internal combustion engine. Thus, the evaluation of the distribution of the pressure gradient characteristic value is not disturbed and falsified by load changes and thus, in particular, by changes in the amount of fuel introduced.

Steps a) and b) are repeated optionally approximately one hundred times, optionally one hundred times, in step c). At any rate, this provides a representative sample with a meaningful distribution of the pressure gradient characteristic values.

Within the scope of the method an internal combustion engine is optionally operated that has a plurality of—optionally identically designed—combustion chambers. In this case, the method is carried out in a customized manner for each combustion chamber, in other words, in particular for each combustion chamber individually. This recognizes in particular that different injectors assigned to different combustion chambers can exhibit vastly different behavior, especially when very small amounts of fuel are being introduced.

According to a further development of the present invention, it is provided that if the actuation of the injector is changed in step e), steps a) to e) are repeated with the changed actuation. In this way, it can be determined whether the changed actuation has led to improved behavior of the injector or has instead worsened the situation. Optionally, this procedure is iterated until the actuation in step e) is maintained. Thus, in particular, steps a) to e) are repeated each time the actuation of the injector is changed in step e), and this is continued until the actuation is maintained for the first time in step e). In this way, a suitable actuation of the injector can be found iteratively—optionally with rapid convergence—in the sense of an as small as possible combustion chamber pressure gradient.

In accordance with a further development of the invention, it is provided that a directional change in the actuation, in other words, in particular in the duration of energization, of the injector is selected in step e) depending on whether a last change in the actuation has led to a greater change in the pressure gradient characteristic value, in particular in an average pressure gradient characteristic value, than a penultimate change in the actuation. The direction of the change is in particular the sign of the change. In particular, the sign is changed compared to the sign selected in the last change step if the last implemented change made to the actuation—that is the duration of energization—resulted in a greater change in the pressure gradient characteristic value than the penultimate change made to the actuation. In contrast, the sign is maintained in comparison with the last change if the last change in actuation did not result in a greater change of the pressure gradient characteristic value than the penultimate change of the actuation.

This approach is based in particular on the idea that the combustion chamber pressure gradient curve has a pronounced curvature originating from its minimum, so that the gradient of the combustion chamber pressure gradient curve changes in both directions originating from the minimum and, in particular, becomes larger in both directions with increasing distance from the minimum. Thus, assuming constant change values or change measures, increasing distance from the minimum results in increasing change in the pressure gradient characteristic value, so this behavior indicates that the sign of the change should be changed in order to progress along the combustion chamber pressure gradient curve toward the minimum.

If, at the beginning of the procedure no previous throughputs are available for evaluation, the sign for the change is optionally chosen randomly or initialized in a predetermined manner.

Alternatively or additionally, the direction of the change of the actuation of the injector in step e) is selected depending on whether a previous change of the actuation has influenced the pressure gradient characteristic in the direction toward a lesser combustion chamber pressure gradient or in the direction toward a greater combustion chamber pressure gradient. The effect of the previous change is thus optionally taken into account when choosing the sign of the subsequent change in order to accelerate the convergence of the process. The direction—in other words the sign—of the change is herein optionally maintained if the previous change in the actuation has influenced the pressure gradient characteristic value in the direction toward a lesser combustion chamber pressure gradient. This means that the change has led in the direction of the desired minimum, so that it is expedient to continue on the chosen path. On the other hand, the direction of the change is optionally changed if the previous change in actuation has influenced the pressure gradient characteristic in the direction of a greater combustion chamber pressure gradient. In this case, the change has contributed to a further distance from the target minimum.

Optionally, an average value of the pressure gradient characteristic value, in particular an average value of the distribution of the pressure gradient characteristic values determined in step c), is considered. In particular, a check is conducted as to whether the preceding change in actuation has influenced the average value of the pressure gradient characteristic value in the direction of a lesser or a greater combustion chamber pressure gradient.

In a first implementation of the method, no preceding change is yet available for evaluation. In this case, the direction of the change in step e) is optionally recommended or determined at random, or a change is made in a predetermined direction.

According to a further development of the invention it is provided that the skew of the distribution in step e) is compared to a predetermined skew threshold value. The actuation of the injector is then optionally changed if the skew is less than the skew threshold value. The actuation is optionally maintained if the skew is greater than the skew threshold value or if the skew is equal to the skew threshold value. If the skew threshold value is exceeded, it is ensured that the actuation signal is already sufficiently close to the optimum value and thus does not need to be corrected further. In particular, the skew threshold value is defined accordingly so that the aforementioned is ensured. If, on the other hand, the skew is less than the skew threshold value, the actuation of the injector is changed and the skew is determined again. This is optionally repeated until the skew reaches or exceeds the skew threshold value.

According to a further development of the present invention, it is provided that the skew of the distribution is determined as a skew measure. This represents a particularly simple detection of the skew which can occur in particular with a minimal computational effort.

According to a first embodiment, the measured value of the skew is determined from the distribution itself, in particular by histogramming the pressure gradient characteristic values and suitably evaluating the histogram. This represents a particularly accurate detection of the skew.

According to an alternative embodiment, the measured value of the skew is determined directly from the determined pressure gradient characteristic values, in particular without explicit determination of the distribution, in particular without the need for histogramming. In this way, the measured value of the skew can be determined very quickly with particularly low computational effort.

Optionally, the measured value of the skew is determined by subtracting the mean value of the pressure gradient characteristic values from the current pressure gradient characteristic value, wherein the result is standardized to the empirical standard deviation or random sample dispersion, raised to the third power, and optionally smoothed over multiple measured values by creating a mean value, in particular a moving mean value or by way of low-pass filters.

Advantageously, no explicit determination of the distribution is required. In particular, the mean value as well as the empirical standard deviation can be estimated recursively from the continuously recorded pressure gradient characteristic values. It is only important that the actuation of the injector remains constant, in other words, that the internal combustion engine runs in particular in a steady operating state.

The measured value of the skew is optionally calculated as the empirical skew v according to the following equation:

$$v = \frac{1}{n} {\sum }_{i = 1}^{n} {( \frac{{x}_{i} - \overline{x}}{s} )}^{3}$$

wherein xᵢ represents the current pressure gradient characteristic value, x̅ the mean value of the pressure gradient characteristic values, s the empirical standard deviation or random sample dispersion and n the size of the sample, in other words, in particular the number of considered pressure gradient characteristic values.

According to a further development of the present invention, it is provided that a combustion chamber pressure value or a structure borne sound value, in particular an integral of a structure borne sound measured value, is used as the pressure gradient characteristic value. In this way, the pressure gradient characteristic value can be determined simply and cost-effectively, in particular by way of combustion chamber sensor technology which is already provided on the internal combustion engine.

According to a further development of the present invention, it is provided that the method is conducted at predetermined time intervals during operation of the internal combustion engine—in particular in predetermined operating hour intervals—in particular in an event-driven manner, for example when initiated by detection of knocking events. In this way, a continuously reliable operation of the internal combustion engine can be ensured.

The present invention also provides a control unit for an internal combustion engine which is designed to conduct the inventive method, or one of the previously described optional embodiments of the method. Advantages are realized in particular in regard to the control unit which have already been explained in the context of the method.

The control unit is designed in particular to actuate an injector, in particular to specify a duration of energization for the injector. The control unit is moreover designed to detect a pressure gradient characteristic value which is characteristic for a combustion chamber pressure gradient in a pressure chamber of the internal combustion engine, assigned to the injector. The control unit is moreover designed to detect a skew of a distribution of detected pressure gradient characteristic values and to change or maintain the actuation of the injector depending on the ascertained skew.

The present invention also provides an internal combustion engine which includes at least one combustion chamber, wherein an injector is assigned to the combustion chamber in order to supply said combustion chamber with fuel. The injector can in particular be actuated to introduce a pre-injection amount of fuel into the combustion chamber. For this purpose, the injector is operatively connected with a control unit of the internal combustion engine, so that the control unit can activate the injector. The internal combustion engine also includes a pressure gradient sensor which is operatively connected with the control unit in order to acquire a measured value from which the control unit can determine a pressure gradient characteristic value which is characteristic for a combustion chamber pressure gradient in the combustion chamber. The pressure gradient sensor is optionally designed to detect a combustion chamber pressure value or structure born sound. The pressure gradient sensor can in particular be designed as a structure borne sound sensor. The control unit is designed to carry out the inventive method or one of the previously described embodiments of the method. The control unit is in particular the control unit according to the present invention, or a control unit in accordance with one of the previously described design examples.

In the context of the internal combustion engine advantages are achieved in particular, which were already explained in connection with the method and the control unit.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a schematic illustration of a design example of an internal combustion engine with a design example of a control unit;

FIG. 2 is a plot of a pressure gradient characteristic value against a pre-injection amount which explains the theoretical background of an embodiment of a method for operating the internal combustion engine; and

FIG. 3 is a schematic illustration of an embodiment of the method in the form of a flow chart.

Corresponding reference characters indicate corresponding parts throughout the several views. The exemplifications set out herein illustrate at least one embodiment of the invention, and such exemplifications are not to be construed as limiting the scope of the invention in any manner.

### DETAILED DESCRIPTION OF THE INVENTION

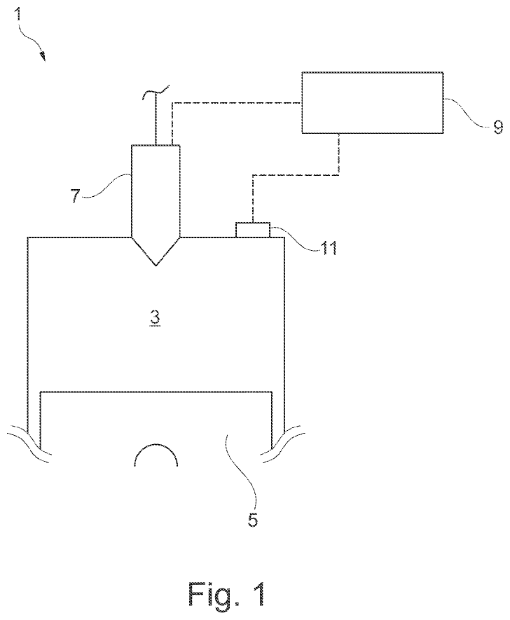

FIG. 1 shows a schematic illustration of a design example of an internal combustion engine 1, which includes at least one combustion chamber 3. Internal combustion engine 1 is herein shown in the optional design of a reciprocating piston engine, with a reciprocating piston 5 assigned to combustion chamber 3. Internal combustion engine 1 includes optionally a plurality of—in particular—identically designed combustion chambers 3.

Combustion chamber 3 has assigned to it an injector 7 which is designed to introduce fuel into combustion chamber 3. Injector 7 can in particular be actuated to introduce a pre-injection amount of the fuel into combustion chamber 3.

Internal combustion engine 1 moreover includes a control unit 9 which is operatively connected with injector 7 in order to actuate injector 7, in particular in such a way that injector 7 can be actuated by way of control unit 9 in order to introduce the pre-injection amount of fuel into combustion chamber 3.

Internal combustion engine 1 moreover includes a pressure gradient sensor 11 which is operatively connected with control unit 9 and which is designed to detect a measured value from which control unit 9 can determine a pressure gradient characteristic value which is characteristic for a combustion chamber pressure gradient in combustion chamber 3. In an optional arrangement, pressure gradient sensor 11 is a structure borne sound sensor.

Control unit 9 is optionally designed to specify a duration of energization for injector 7.

Control unit 9 is moreover designed to conduct a method which is described in further detail below:

Injector 7 is actuated a) in order to introduce the pre-injection amount into combustion chamber 3; wherein b) the compression gradient characteristic value is determined for one operating cycle of combustion chamber 3 in which injector 7 was actuated in step a); wherein c) steps a) and b) are repeated multiple times; wherein in d) a skew of a distribution of the pressure gradient characteristic values which were determined in step c) is established and; wherein actuation of injector 7 is changed or maintained depending on the skew established in step d).

In particular, if actuation of injector 7 is altered in step c), steps a) through e) are repeated with the changed actuation, wherein this is iterated until the actuation in step e) is maintained for the first time.

A direction of the change in the actuation of injector 7 in step e) is optionally selected depending on whether a preceding change in actuation—in the immediately preceding iteration—has influenced the pressure gradient characteristic value in the direction of a smaller or in the direction of a greater combustion chamber pressure gradient.

The skew of the distribution is optionally compared to a predetermined skew threshold value in step e), wherein the actuation of injector 7 is changed if the skew is less than the pre-specified skew threshold value, and wherein the actuation of injector 7 is maintained if the skew is greater than or equal to the pre-specified skew threshold value.

The skew is optionally determined as a measured value of the skew, in particular from the distribution of the pressure gradient characteristic values themselves, or in an especially optional design, directly from the ascertained pressure gradient characteristic values in particular without explicit determination of the distribution.

In an optional arrangement, a combustion chamber pressure value, or a structure-borne sound value, in particular an integral of a structure-borne sound sensor measured value, is used as the pressure gradient characteristic value.

The method is optionally conducted in predetermined time intervals or in an event-driven manner during operation of the internal combustion engine.

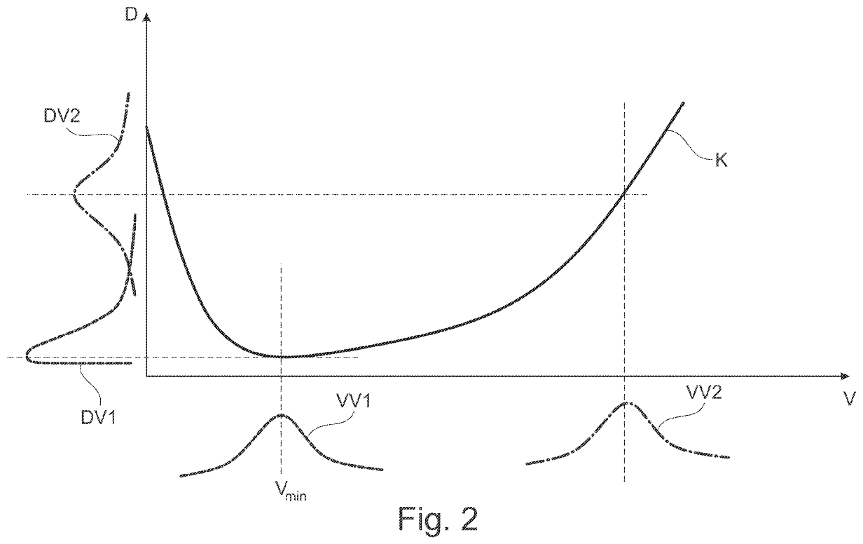

FIG. 2 shows a diagrammatic plot of a pressure gradient characteristic value D in arbitrary units against a pre-injection amount V, also in arbitrary units, wherein pre-injection amount V is in particular an amount of fuel introduced into combustion chamber 3 by way of pre-injection by way of injector 7. Pressure gradient characteristic value D follows a curve K depending on the pre-injection amount, which—at a certain pre-injection amount Vₘᵢₙ—exhibits a minimum and increases on the one hand to pre-injection amounts less than the specified pre-injection amount Vₘᵢₙ and on the other hand to pre-injection amounts greater than the specified pre-injection amount Vₘᵢₙ. Curve K is flat within the range of the minimum, which makes a classic minimum search more difficult.

The concept of the minimum search based on the skew of the distribution of the pressure gradient characteristic values and thereby the theoretical background of the method proposed herein will be explained in more detail below with reference to FIG. 2.

If—in order to inject a pre-injection amount V—injector 7 is activated multiple times with the same actuation, in particular the same energization duration, the result is a pre-injection amount distribution of the pre-injection amounts V actually introduced into combustion chamber 3. This pre-injection amount distribution can be assumed to be symmetrical; in particular, this pre-injection amount distribution can assume the form of a bell curve, especially a Gaussian bell curve.

FIG. 2 illustrates a first pre-injection distribution VV1 which results from an actuation of injector 7 in the range of the minimum of curve K. The maximum of the first pre-injection amount VV1 is shown in particular on the specified pre-injection amount Vₘᵢₙ. Now, based on the progression of curve K, the result is a corresponding first pressure gradient characteristic value distribution DV1. This shows a pronounced skew with a pronounced shift of its maximum towards small pressure gradient characteristic values, especially since most of the pre-injection amount values within the first pre-injection amount distribution VV1 lead to pressure gradient characteristic values in the minimum range. In addition, there is the pronounced asymmetry as well as the flat progression of curve K towards greater pre-injection amounts, which ultimately leads to the fact that virtually the entire right branch of the first pre-injection amount distribution VV1 is mapped onto comparatively small pressure gradient characteristic values.

If, in contrast we consider a second pre-injection amount distribution VV2, the maximum of which is a much greater pre-injection amount, this enters in particular into a range in which curve K rises almost linearly. Accordingly, based on the progression of curve K a corresponding second pressure gradient distribution DV2 results, which is at least essentially symmetrical, and whose shape essentially corresponds to the shape of the second pre-injection amount distribution VV2.

Based on FIG. 2 it becomes immediately clear that the skew of the distribution of the pressure gradient characteristic values is a suitable measure for determining how close a specified actuation of injector 7 brings the pre-injection amount V introduced by the latter into the minimum range of the pressure gradient characteristic value.

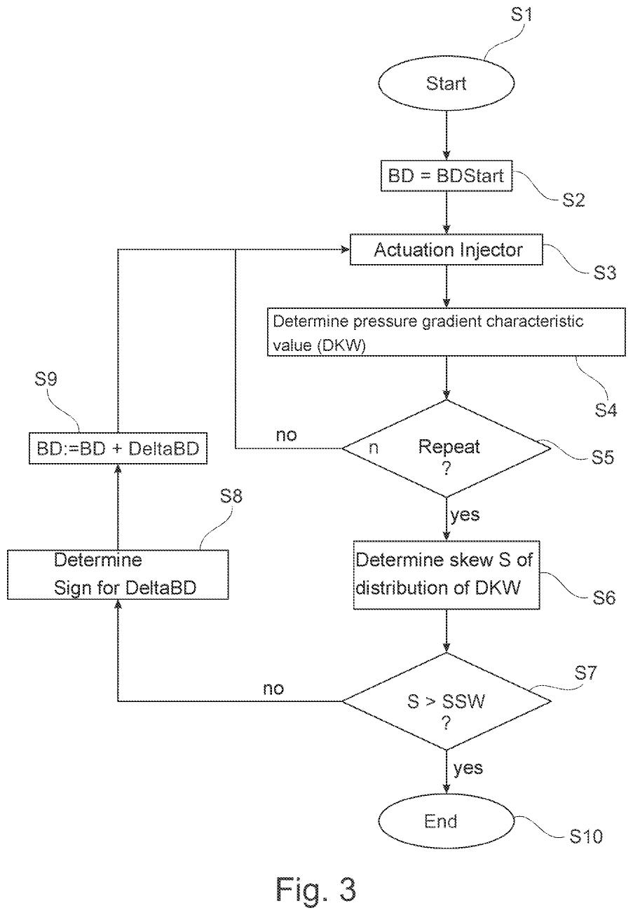

FIG. 3 is a schematic illustration of one embodiment of a process for operating internal combustion engine 1 in the form of a flow chart. The process starts in first step S1. In second step S2 a duration of energization BD for injector 7 is initialized with a pre-specified starting value BDstart.

In third step S3, injector 7 is actuated with duration of energization BD in order to introduce a pre-injection amount of fuel into combustion chamber 3. In fourth step S4, a pressure gradient characteristic value DKW is specified for the operating cycle of combustion chamber 3 in which injector 7 was previously actuated in third step S3, wherein pressure gradient characteristic value DKW is characteristic for a combustion chamber gradient in combustion chamber 3.

In fifth step S5 it is queried whether a pre-specified number n of repeats of steps S3, S4 were conducted. As long as this is not yet the case, the process is continued in third step S3; in other words, steps S3 to S5 are repeated until the pre-specified number n of repeats is reached. The pre-specified number n may for example be 100. Thus, in this respect n pressure gradient characteristic values and in this respect also—either explicitly or at least implied—a distribution of the pressure gradient characteristic values are obtained.

On reaching the pre-specified number n of repeats, the process is continued in step S6, where a skew S of the distribution of pressure gradient characteristic values DKW is determined. Determination of skew S may occur either after having established the distribution from the distribution itself, or without explicit determination of the distribution. Skew S is optionally calculated as an empirical skew v according to equation (1) provided above.

In seventh step S7, skew S is compared with a pre-specified skew threshold value SSW. If it is observed that skew S is not greater than the pre-specified skew threshold value SSW, a sign for an otherwise optional constant, in particular pre-determined change value DeltaBD for changing the duration of energization BD is determined in step S8. In step S9, the duration of energization BD is newly defined as a sum of the previous value of the duration of energization BD and change value DeltaBD for the duration of energization, inclusive of the sign; in other words, change value DeltaBD itself is signed. The process is then continued in third step S3 with the new value for the energization duration BD determined in ninth step S9; in other words, injector 7 is actuated with the new value for energization duration BD.

The sign for change value DeltaBD is selected in step S8, in particular depending on whether the last change in actuation has resulted in a greater change of the pressure gradient characteristic value—in particular of the average pressure gradient characteristic value—than the penultimate change in actuation. In particular, the sign is changed compared to the sign selected in the last change step if the last change made to the energization duration resulted in a greater change in the pressure gradient characteristic value than the penultimate change made to the energization duration. In contrast, the sign is maintained compared to the last change if the last change in the energization duration did not lead to a greater change of the pressure gradient characteristic value than the penultimate change of the energization duration. This is based on the idea that curve K according to FIG. 2 displays a pronounced curvature originating from its minimum, so that the gradient of curve K changes in both directions, originating from the minimum and becomes larger in both directions in particular with increasing distance from the minimum. Thus, on the basis of constant change values DeltaBD, there is a growing change in the pressure gradient characteristic value with increasing distance from the minimum, so that this behavior indicates that the sign of change value DeltaBD should be changed to move along curve K in the direction of the minimum.

If no previous cycles of the process are yet available for evaluation in step S8, the sign for change value DeltaBD is optionally randomly selected or initialized in a predetermined manner.

The amount of change value DeltaBD and/or the amount of start value BDStart is/are optionally parameterizable. Likewise, the skew threshold SSW is optionally parameterizable.

If it is observed in step S7 that skew S is greater than the pre-specified skew threshold value SSW, the process ends in a tenth step S10.

The entire process is repeated optionally during operation of internal combustion engine 1 at predetermined time intervals or in an event-driven manner.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A method for operating an internal combustion engine, the method comprising the steps of:
(a) actuating an injector to introduce a pre-injection amount of a fuel into a combustion chamber of the internal combustion engine;
(b) determining, for an operating cycle of the combustion chamber in which the injector was actuated in the step (a), a pressure gradient characteristic value which is characteristic of a combustion chamber pressure gradient in the combustion chamber;
(c) repeating the steps (a) and (b) a plurality of times;
(d) determining a skew of a distribution of a plurality of pressure gradient characteristic values determined in the step (c); and
(e) changing or maintaining an actuation of the injector depending on the skew determined in the step (d).

2. The method according to claim 1, wherein, if the actuation of the injector is changed in the step (e), the steps (a) to (e) are repeated with a changed actuation.

3. The method according to claim 1, wherein, if the actuation of the injector is changed in the step (e), the method includes repeating the steps (a) to (e) with a changed actuation, the repeating being iterated until the actuation of the injector in the step (e) is maintained.

4. The method according to claim 1, wherein a directional change in the actuation of the injector is selected in the step (e) depending on whether a last change in the actuation of the injector has led to a greater change in the pressure gradient characteristic value than a penultimate change in the actuation of the injector.

5. The method according to claim 1, wherein a directional change in the actuation of the injector is selected in the step (e) depending on whether a last change in the actuation of the injector has led to a greater change in an average pressure gradient characteristic value than a penultimate change in the actuation of the injector.

6. The method according to claim 1, wherein the skew of the distribution is compared in the step (e) to a predetermined skew threshold value, wherein the actuation of the injector is changed if the skew is less than the predetermined skew threshold value, and wherein the actuation of the injector is maintained if the skew is greater than or equal to the predetermined skew threshold value.

7. The method according to claim 1, wherein the skew is determined as a measured value of the skew.

8. The method according to claim 1, wherein the skew is determined as a measured value of the skew, (i) from the distribution of the plurality of pressure gradient characteristic values, or (ii) directly from a plurality of pressure gradient characteristic values which are determined.

9. The method according to claim 1, wherein a combustion chamber pressure value or a structure-borne sound value is used as the pressure gradient characteristic value.

10. The method according to claim 1, wherein a combustion chamber pressure value or an integral of a structure-borne sound sensor measured value is used as the pressure gradient characteristic value.

11. The method according to claim 1, wherein the method is conducted in predetermined time intervals or in an event-driven manner during an operation of the internal combustion engine.

12. A control unit for an internal combustion engine, the control unit comprising:
the control unit, which is configured for conducting a method for operating the internal combustion engine, the method comprising the steps of:
(a) actuating an injector to introduce a pre-injection amount of a fuel into a combustion chamber of the internal combustion engine;
(b) determining, for an operating cycle of the combustion chamber in which the injector was actuated in the step (a), a pressure gradient characteristic value which is characteristic of a combustion chamber pressure gradient in the combustion chamber;
(c) repeating the steps (a) and (b) a plurality of times;
(d) determining a skew of a distribution of a plurality of pressure gradient characteristic values determined in the step (c); and
(e) changing or maintaining an actuation of the injector depending on the skew determined in the step (d).

13. An internal combustion engine, comprising:
at least one combustion chamber;
an injector which is assigned to the combustion chamber in order to supply the combustion chamber with a fuel;
a control unit, the injector being operatively connected with the control unit of the internal combustion engine and thereby the control unit is configured for activating the injector;
a pressure gradient sensor which is operatively connected with the control unit, the pressure gradient sensor being configured for detecting a measured value, the control unit being configured for determining a pressure gradient characteristic value from the measured value which is characteristic for a combustion chamber pressure gradient in the combustion chamber, the control unit being configured for carrying out a method for operating the internal combustion engine, the method comprising the steps of:
(a) actuating the injector to introduce a pre-injection amount of the fuel into the combustion chamber of the internal combustion engine;
(b) determining, for an operating cycle of the combustion chamber in which the injector was actuated in the step (a), the pressure gradient characteristic value which is characteristic of the combustion chamber pressure gradient in the combustion chamber;
(c) repeating the steps (a) and (b) a plurality of times;
(d) determining a skew of a distribution of a plurality of pressure gradient characteristic values determined in the step (c); and
(e) changing or maintaining an actuation of the injector depending on the skew determined in the step (d).
